(19) United States
(12) Patent Application Publication
(10) Pub. No.: US 2024/0381025 A1
(43) Pub. Date: Nov. 14, 2024

(54) BEAMFORMING FOR A MICROPHONE ARRAY BASED ON A STEERED RESPONSE POWER TRANSFORMATION OF AUDIO DATA

(71) Applicant: SHURE ACQUISITION HOLDINGS, INC., Niles, IL (US)

(72) Inventors: Wenshun Tian, Palatine, IL (US); Michael Lester, Buena Vista, CO (US)

(21) Appl. No.: 18/660,424

(22) Filed: May 10, 2024

Related U.S. Application Data
(60) Provisional application No. 63/501,572, filed on May 11, 2023.

(51) Int. Cl. H04R 1/40; G10L 21/0216; H04R 3/00; H04S 7/00

(52) U.S. Cl. CPC H04R 1/406; G10L 21/0216; H04R 3/005; H04S 7/303; G10L 2021/02166; H04R 2201/40; H04R 2430/21

(57) ABSTRACT

Techniques are disclosed herein for providing beamforming for at least one microphone array based at least in part on a steered response power (SRP) transformation of audio data. Examples may include receiving audio data from multiple audio capture devices comprising at least one microphone array located within an audio environment. Examples may also include generating an SRP transformation of the audio data. The SRP transformation may comprise a set of SRP weights for a spatial coordinate grid representing the audio environment. Examples may also include performing, based at least in part on a signal-to-noise ratio (SNR) estimate associated with the SRP transformation, one or more of beamforming steering or beamforming selection with respect to the at least one linear array microphone.

### CROSS REFERENCE TO RELATED APPLICATIONS

This application claims the benefit of U.S. Provisional Patent Application No. 63/501,572, titled “BEAMFORMING FOR A MICROPHONE ARRAY BASED ON A STEERED RESPONSE POWER TRANSFORMATION OF AUDIO DATA,” and filed on May 11, 2023, the entirety of which is hereby incorporated by reference.

### TECHNICAL FIELD

Embodiments of the present disclosure relate generally to audio processing and, more particularly, to systems configured to provide beamforming for a microphone array.

### BACKGROUND

An array of microphones may be employed to capture audio from an audio environment. Respective microphones of an array of microphones are often located at fixed positions within an audio environment and often employ beamforming to capture audio from a source of audio. However, a location of a source of audio captured by an array of microphones may change within an audio environment. Additionally, for an audio environment with multiple microphone arrays, inefficiencies and/or errors related to audio processing for the respective microphone arrays may result in inaccuracies for beamforming.

### BRIEF SUMMARY

Various embodiments of the present disclosure are directed to apparatuses, systems, methods, and computer readable media for providing beamforming for a microphone array based on a steered response power transformation of audio data. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example beamforming audio processing system configured to execute steered response power (SRP) transformation operations and beamforming operations in accordance with one or more embodiments disclosed herein;

FIG. 2 illustrates an example beamforming audio processing apparatus configured in accordance with one or more embodiments disclosed herein;

FIG. 3 illustrates an example a beamforming audio processing flow for audio processing enabled by an SRP transformation engine and a beamforming steering engine in accordance with one or more embodiments disclosed herein;

FIG. 4 illustrates an example a beamforming audio processing flow for audio processing enabled by an SRP transformation engine and a beamforming selection engine in accordance with one or more embodiments disclosed herein;

FIG. 5 illustrates an example audio environment in accordance with one or more embodiments disclosed herein; and

FIG. 6 illustrates an example method for providing beamforming for at least one microphone array based on an SRP transformation of audio data in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

A typical audio system for capturing audio within an audio environment may contain a microphone array, a beamforming module, and/or other digital signal processing (DSP) elements. For example, a beamforming module may be configured to combine microphone signals captured by a microphone array using one or more DSP processing techniques. Typically, beamforming lobes of a microphone array may be directed to capture audio at fixed locations within an audio environment. However, traditional beamforming techniques often involve numerous microphone elements, expensive hardware, and/or manual setup for beam steering or microphone placement in an audio environment.

Additionally, since certain types of audio sources such as a human talker in an audio environment may dynamically change location within the audio environment, beamforming lobes of a microphone array are often re-steered to attempt to capture the dynamic audio source. The re-steering of beamforming lobes of a microphone array often results in inefficient usage of computing resources, inefficient data bandwidth, and/or undesirable audio delay by an audio system. For example, re-steering of beamforming lobes may involve localization processing that may inefficiently consume computational resources for an audio processing pipeline and/or may introduce error that compromises alignment of beamforming lobes with an audio source. Re-steering of beamforming lobes may also introduce delay in an audio processing pipeline in order to obtain a localization measure, thereby delaying deployment of the beamforming lobes.

Moreover, re-steering beamforming lobes of respective microphone arrays for an audio environment with multiple microphone arrays may not adequately capture each audio source in the audio environment, resulting in inefficiencies and/or inaccuracies with respect to beamforming for the microphone arrays. Noise is also often introduced during audio capture related to audio systems, which may further impact intelligibility of speech and/or may produce an undesirable experience for listeners. As such, it is desirable to improve beamforming for microphone arrays in an audio environment.

To address these and/or other technical problems associated with traditional microphone array systems, various embodiments disclosed herein provide beamforming for a microphone array based on a steered response power (SRP) transformation of audio data. The SRP transformation may provide a set of SRP weights for the audio data. To facilitate beamforming for the microphone array, the set of SRP weights may be related to a spatial coordinate grid representing an audio environment that includes the microphone array. For example, the SRP transformation may be based on beamformed audio output from a spatial filter with predefined coefficients for a predefined spatial coordinate grid representing respective locations of the audio environments. Additionally, the SRP transformation may be employed for improved beamforming steering and/or improved beamforming selection for a microphone array.

### Exemplary Beamforming Audio Processing Systems and Methods

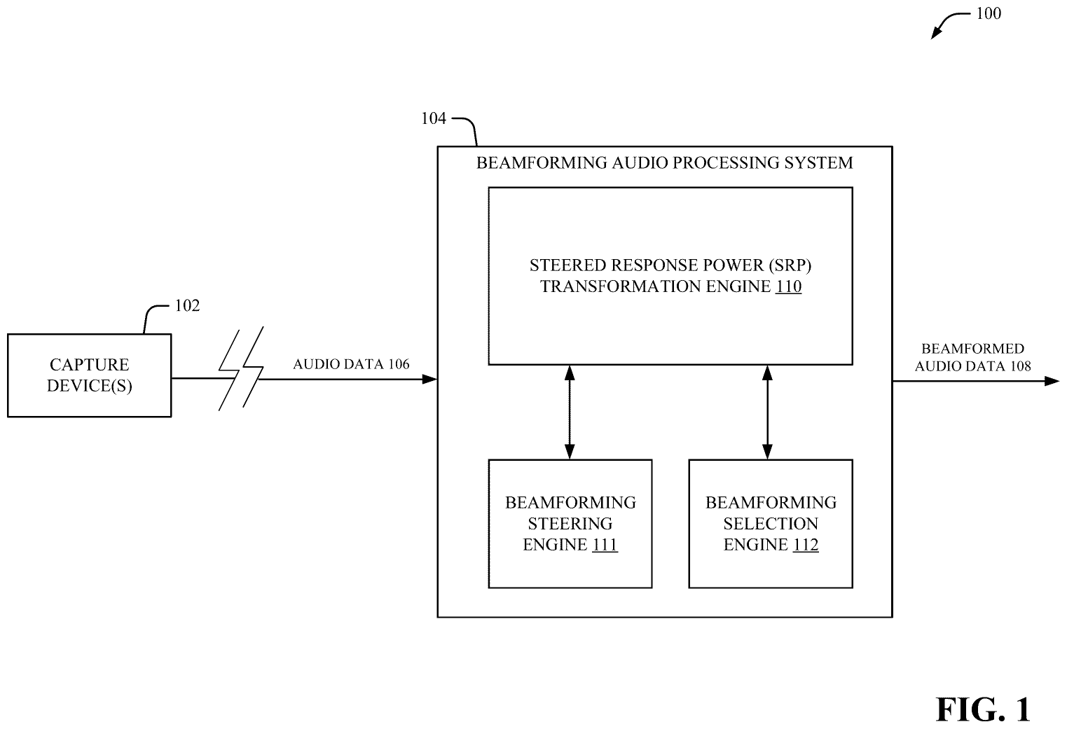

FIG. 1 illustrates an audio signal processing system 100 that is configured to provide beamforming for a microphone array based on an SRP transformation of audio data, according to embodiments of the present disclosure. The audio signal processing system 100 may be, for example, a conferencing system (e.g., a conference audio system, a video conferencing system, a digital conference system, etc.), an audio performance system, an audio recording system, a music performance system, a music recording system, a digital audio workstation, a lecture hall microphone systems, a broadcasting microphone system, an augmented reality system, a virtual reality system, an online gaming system, or another type of audio system. Additionally, the audio signal processing system 100 may be implemented as an audio signal processing apparatus and/or as software that is configured for execution on a smartphone, a laptop, a personal computer, a digital conference system, a wireless conference unit, an audio workstation device, an augmented reality device, a virtual reality device, a recording device, headphones, earphones, speakers, or another device. The audio signal processing system 100 disclosed herein may additionally or alternatively be integrated into a virtual DSP processing system (e.g., DSP processing via virtual processors or virtual machines) with other conference DSP processing.

The audio signal processing system 100 may utilize the SRP transformation to provide various improvements related to beamforming such as, for example, to: automatically track a sound source in an audio environment, generate a steering lobe based on a tracked location of a sound source, update a coordinate change related to beamforming, provide self-steering based on a tracked location of a sound source, improve localization accuracy associated with beamforming, improve efficiency of deploying a microphone array in an audio environment, minimize external inputs for steering coordinates related to beamforming, reduce noise in an audio environment, select a beamforming scheme for optimal beamforming for two or more independent microphone arrays in an audio environment, and/or improve one or more other beamforming processes related to a microphone array.

The audio signal processing system 100 may also be adapted to produce improved audio signals with reduced noise, reverberation, and/or other undesirable audio artifacts. In applications focused on reducing noise, such reduced noise may be stationary and/or non-stationary noise. Additionally, the audio signal processing system 100 may provide improved audio quality for audio signals in an audio environment. An audio environment may be an indoor environment, an outdoor environment, a room, a performance hall, a broadcasting environment, a sports stadium or arena, a virtual environment, or another type of audio environment. In various examples, the audio signal processing system 100 may be configured to remove or suppress noise, reverberation, and/or other undesirable sound from audio signals via digital signal processing. The audio signal processing system 100 may alternatively be employed for another type of sound enhancement application such as, but not limited to, active noise cancelation, adaptive noise cancelation, etc.

The audio signal processing system 100 comprises one or more capture devices 102. The one or more capture devices 102 may respectively be audio capture devices configured to capture audio from one or more sound sources. The one or more capture devices 102 may include one or more sensors configured for capturing audio by converting sound into one or more electrical signals. The audio captured by the one or more capture devices 102 may also be converted into audio data 106. The audio data 106 may be a digital audio data or, alternatively, analog audio data, related to the one or more electrical signals.

In an example, the one or more capture devices 102 are one or more microphones arrays. For example, the one or more capture devices 102 may correspond to one or more array microphones, one or more beamformed lobes of an array microphone, one or more linear array microphones, one or more ceiling array microphones, one or more table array microphones, or another type of array microphone. In alternate examples, the one or more capture devices 102 are another type of capture device such as, but not limited to, one or more condenser microphones, one or more micro-electromechanical systems (MEMS) microphones, one or more dynamic microphones, one or more piezoelectric microphones, one or more virtual microphones, one or more network microphones, one or more ribbon microphones, and/or another type of microphone configured to capture audio. It is to be appreciated that, in certain examples, the one or more capture devices 102 may additionally or alternatively include one or more video capture devices, one or more infrared capture devices, one or more sensor devices, and/or one or more other types of audio capture devices. Additionally, the one or more capture devices 102 may be positioned within a particular audio environment.

The audio signal processing system 100 also comprises a beamforming audio processing system 104. The beamforming audio processing system 104 may be configured to perform one or more beamforming processes with respect to the audio data 106 to provide beamformed audio data 108. The beamforming audio processing system 104 depicted in FIG. 1 includes an SRP transformation engine 110, a beamforming steering engine 111, and/or a beamforming selection engine 112. The beamforming audio processing system 104 may utilize the SRP transformation engine 110, the beamforming steering engine 111, and/or the beamforming selection engine 112 to convert the audio data 106 into the beamformed audio data 108. For instance, the SRP transformation engine 110 may generate an SRP transformation of the audio data 106. The SRP transformation may provide a set of SRP weights for a spatial coordinate grid representing an audio environment that includes the one or more capture devices 102. In some examples, the spatial coordinate grid may be a two-dimensional mapping of the audio environment where respective two-dimensional coordinates may represent respective locations within the audio environment. An SRP weight may be a weight for spatial filtering, beamforming, and/or other audio processing associated with the audio data 106. Additionally, an SRP weight may be configured based on steered response power associated with spatial characteristics of the audio data 106.

In some examples, an SRP weight may correspond to and/or be modified based on a steered response power value. In some examples, the spatial characteristics may be associated with arrival time, amplitude, phase, power spectrums, audio localization, and/or one or more other spatial characteristics associated with the audio data 106.

In some examples, the SRP transformation engine 110 may apply predefined beamforming coefficients to respective values of the spatial coordinate grid to generate the SRP transformation. For example, the SRP transformation engine 110 may calculate the SRP transformation based on beamformed audio output from a spatial filter with predefined coefficients for respective predefined grid locations of the spatial coordinate grid.

To facilitate execution of one or more beamforming processes related the beamforming steering engine 111 or the beamforming selection engine 112, the SRP transformation engine 110 may also determine a signal-to-noise ratio (SNR) estimate associated with the SRP transformation. For example, based on a value of the SNR estimate associated with the SRP transformation, the beamforming audio processing system 104 may select either the beamforming steering engine 111 or the beamforming selection engine 112 to perform one or more beamforming processes with respect to the one or more capture devices 102. In some examples, the SRP transformation engine 110 may determine the SNR estimate using unity-gain steering properties and/or null-gain steering properties of the audio data 106. For instance, the SRP transformation may include a first SRP transformation calculated from output of a unity-gain beamformer and a second SRP transformation calculated from a null-gain beamformer. Additionally, the SNR estimate may correspond to a ratio of the first SRP transformation and the second SRP transformation.

Based at least in part on the beamforming steering associated with the beamforming steering engine 111 or the beamforming selection associated with the beamforming selection engine 112, the beamforming audio processing system 104 may output the beamformed audio data 108. For beamforming steering related to the beamforming steering engine 111, the beamformed audio data 108 may be steering coordinates for at least one beamforming lobe related to beamforming steering. In some examples, the steering coordinates may indicate a specific direction or location for steering the at least one beamforming lobe. In some examples, the steering coordinates may include a position of one or more microphone sensor array elements, an azimuth steering angle between one or more microphone sensor array elements and an audio source, an elevation angle between one or more microphone sensor array elements and an audio source, and/or other information for controlling beamforming steering. Alternatively, for beamforming selection related to the beamforming selection engine 112, the beamformed audio data 108 may be a selection of a first capture device or a second capture device from the one or more capture devices 102. For example, the beamformed audio data 108 may be a selection of a first microphone array or a second microphone array in an audio environment for beamforming. In some examples, beamforming selection may include selection of a beamforming lobe for a microphone array to output the beamformed audio data 108, where the selection of the beamforming lobe is based at least in part on the SNR estimate associated with the SRP transformation.

In some examples, the beamforming audio processing system 104 may output the beamformed audio data 108 based at least in part on a combination of the beamforming steering associated with the beamforming steering engine 111 and the beamforming selection associated with the beamforming selection engine 112. In such instances, a first microphone array and a second microphone array in an audio environment may respectively perform beamforming steering to respective locations in the audio environment via the beamforming steering engine 111. Additionally, the beamforming selection engine 112 may compare one or more beam patterns of the first microphone array and the second microphone array to select an optimal beam for adaptive beam steering.

In some examples, the SRP transformation engine 110 may determine steering coordinates for at least one beamforming lobe associated with the one or more capture devices 102 based at least in part on the SRP transformation of the audio data 106. In some examples, the SRP transformation engine 110 may determine the steering coordinates based at least in part on the SRP transformation and predefined beamforming weights associated with the spatial coordinate grid. Additionally, the beamforming steering engine 111 may perform the beamforming steering or the beamforming selection engine 112 may perform the beamforming selection with respect to the one or more capture devices 102 based at least in part on the steering coordinates.

In some examples, the beamforming steering engine 111 may apply spatial filtering of the audio data 106 based at least in part on the steering coordinates to generate the beamformed audio data 108. The spatial filtering may include noise reduction, source separation, virtual surround sound augmentation, binaural audio rending, three-dimensional audio augmentation, and/or other spatial filtering of the audio data 106. Additionally, the beamforming steering engine 111 may output the beamformed audio data 108 toward a sound source associated with the steering coordinates. In some examples, the beamforming steering engine 111 may determine a confidence value for the steering coordinates based at least in part on the SNR estimate. The beamforming steering engine 111 may additionally or alternatively determine the confidence value for the steering coordinates based at least in part by triangulating position between respective microphone arrays. Additionally, the beamforming steering engine 111 may apply the apply the spatial filtering and/or update beamforming weights for the audio data 106 based on the confidence value satisfying a confidence threshold. In some examples, the confidence value may represent a confidence score, a degree of confidence and/or a defined confidence threshold related to accuracy.

In some examples, the beamforming steering engine 111 may compare the SNR estimate to a different SNR estimate for a different capture device. Additionally, the beamforming steering engine 111 may generate the beamformed audio data 108 based on a determination that the SNR estimate is greater than the different SNR estimate.

In some examples, the beamforming steering engine 111 may determine steering coordinates for at least one beamforming lobe associated with the one or more capture devices 102 based at least in part on the SRP transformation of the audio data 106. Additionally, the beamforming steering engine 111 may compare the steering coordinates against predefined polar patterns and/or a previous beamformed frame to verify the steering coordinates. In some examples, the beamforming steering engine 111 may compare respective polar patterns from a null-gain beamformer and a unity-gain beamformer at defined locations (e.g., defined locations different from steered locations of the spatial coordinate grid). The beamforming steering engine 111 may then perform the beamforming steering based at least in part on the steering coordinates.

In some examples, the beamforming steering engine 111 may determine the steering coordinates in parallel to a different beamforming process for the audio data 106. For example, the beamforming steering engine 111 may determine the steering coordinates in parallel to a beamforming process performed without an SRP transformation of the audio data 106.

The beamforming selection engine 112 may select a first capture device or a second capture device from the one or more capture devices 102 to output the beamformed audio data 108. To select the first capture device or the second capture device from the one or more capture devices 102, the beamforming selection engine 112 may utilize the SRP transformation of the audio data 106. For example, the beamforming selection engine 112 may utilize the SRP transformation of the audio data 106 as an indicator to determine an optimal capture device to output the beamformed audio data 108. In some examples, the beamforming selection engine 112 may determine, based on the SRP transformation of the audio data 106, whether to maintain the first capture device as a capture device to output the beamformed audio data 108, or to switch to the second capture device as a capture device to output the beamformed audio data 108. In other examples, the beamforming selection engine 112 may determine, based on the SRP transformation of the audio data 106, whether to maintain the second capture device as a capture device to output the beamformed audio data 108, or to switch to the first capture device as a capture device to output the beamformed audio data 108.

In some examples, the beamforming selection engine 112 may select a first capture device or a second capture device from the one or more capture devices 102 to output the beamformed audio data 108 based at least in part on a comparison between the SRP transformation of the audio data 106 and an alternate SRP transformation of the audio data 106. The SRP transformation may be associated with a first portion of the audio data 106 related to the first capture device and the alternate SRP transformation may be associated with a second portion of the audio data 106 related to the second capture device.

In some examples, the beamformed audio data 108 may include beamforming coefficients that provide unity-gain at a steered direction based on the steering coordinates. In some examples, the beamforming coefficients may provide both a unity-gain at the steered direction and a null-gain at one or more undesirable directions in the audio environment. The undesirable directions may be predefined noise sources in the audio environment. Alternatively, noise sources in the audio environment may be classified based on respective SRP transforms. For example, a first audio source associated with a first SRP (e.g., a highest SRP location) may be classified as a desirable audio source and a second audio source associated with a second SRP (e.g., a second highest SRP location) may be classified as an undesirable audio source.

In some examples, the beamformed audio data 108 may be further processed via audio post-processing and/or one or more other audio processing components such as an equalizer, a spectral estimator, and/or another audio processing component. In some examples, the beamformed audio data 108 may be employed to determine an inverse room equalizer for the audio environment to apply to a selected beam.

Accordingly, the beamforming audio processing system 104 may provide improved beamforming for the audio data 106 as compared to traditional beamforming techniques. Additionally, accuracy of localization of a sound source in an audio environment may be improved by employing the beamforming audio processing system 104. The beamforming audio processing system 104 may additionally or alternatively be adapted to produce improved audio signals with reduced noise, reverberation, and/or other undesirable audio artifacts even in view of exacting audio latency requirements. For example, the beamforming audio processing system 104 may remove or suppress undesirable noise for predefined noise locations in an audio environment and/or for noise locations provided via source localization. As such, audio may be provided to a user without the undesirable sound reflections. The beamforming audio processing system 104 may also improve runtime efficiency of denoising, dereverberation, and/or other audio filtering while also optimizing beamforming of audio. Moreover, the beamforming audio processing system 104 may be implemented without synchronizing microphone components of different microphone arrays with a single clock structure.

The beamforming audio processing system 104 may also employ fewer of computing resources when compared to traditional audio processing systems that are used for beamforming. Additionally or alternatively, in some examples, the beamforming audio processing system 104 may be configured to deploy a smaller number of memory resources allocated to beamforming, denoising, dereverberation, and/or other audio filtering for an audio signal sample such as, for example, the audio data 106. In some examples, the beamforming audio processing system 104 may be configured to improve processing speed of beamforming operations, denoising operations, dereverberation operations, and/or audio filtering operations. These improvements may enable an improved audio processing systems to be deployed in microphones or other hardware/software configurations where processing and memory resources are limited, and/or where processing speed and efficiency is important.

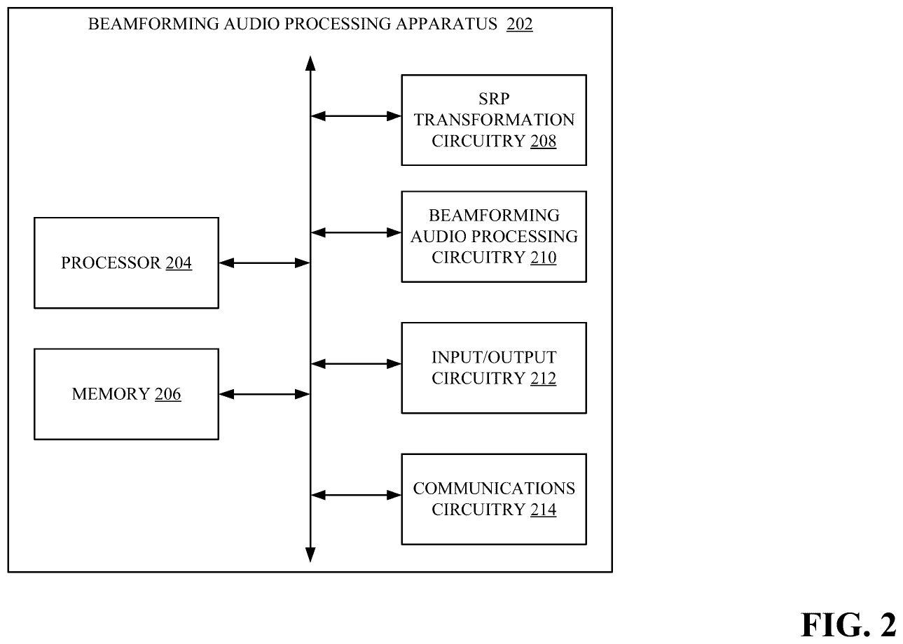

FIG. 2 illustrates an example beamforming audio processing apparatus 202 configured in accordance with one or more embodiments of the present disclosure. The beamforming audio processing apparatus 202 may be configured to perform one or more techniques described in FIG. 1 and/or one or more other techniques described herein.

The beamforming audio processing apparatus 202 may be a computing system communicatively coupled with one or more circuit modules related to audio processing. The beamforming audio processing apparatus 202 may comprise or otherwise be in communication with a processor 204, a memory 206, SRP transformation circuitry 208, beamforming audio processing circuitry 210, input/output circuitry 212, and/or communications circuitry 214. In some examples, the processor 204 (which may comprise multiple or co-processors or any other processing circuitry associated with the processor) may be in communication with the memory 206.

The memory 206 may comprise non-transitory memory circuitry and may comprise one or more volatile and/or non-volatile memories. In some examples, the memory 206 may be an electronic storage device (e.g., a computer readable storage medium) configured to store data that may be retrievable by the processor 204. In some examples, the data stored in the memory 206 may comprise audio data, stereo audio signal data, mono audio signal data, radio frequency signal data, SRP transformation data, a set of SRP weights, or the like, for enabling the beamforming audio processing apparatus 202 to carry out various functions or methods in accordance with embodiments of the present disclosure, described herein.

In some examples, the processor 204 may be embodied in a number of different ways. For example, the processor 204 may be embodied as one or more of various hardware processing means such as a central processing unit (CPU), a microprocessor, a coprocessor, a DSP, a field programmable gate array (FPGA), a neural processing unit (NPU), a graphics processing unit (GPU), a system on chip (SoC), a cloud server processing element, a controller, or a processing element with or without an accompanying DSP. The processor 204 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some examples, the processor 204 may comprise one or more processing cores configured to perform independently. A multi-core processor may enable multiprocessing within a single physical package. Additionally or alternatively, the processor 204 may comprise one or more processors configured in tandem via a bus to enable independent execution of instructions, pipelining, and/or multithreading.

In some examples, the processor 204 may be configured to execute instructions, such as computer program code or instructions, stored in the memory 206 or otherwise accessible to the processor 204. Alternatively or additionally, the processor 204 may be configured to execute hard-coded functionality. As such, whether configured by hardware or software instructions, or by a combination thereof, the processor 204 may represent a computing entity (e.g., physically embodied in circuitry) configured to perform operations according to an embodiment of the present disclosure described herein. For example, when the processor 204 is embodied as an CPU, DSP, ARM, FPGA, ASIC, or similar, the processor may be configured as hardware for conducting the operations of an embodiment of the disclosure. Alternatively, when the processor 204 is embodied to execute software or computer program instructions, the instructions may specifically configure the processor 204 to perform the algorithms and/or operations described herein when the instructions are executed. However, in some examples, the processor 204 may be a processor of a device specifically configured to employ an embodiment of the present disclosure by further configuration of the processor using instructions for performing the algorithms and/or operations described herein. The processor 204 may further comprise a clock, an arithmetic logic unit (ALU) and logic gates configured to support operation of the processor 204, among other things.

In one or more examples, the beamforming audio processing apparatus 202 may comprise the SRP transformation circuitry 208. The SRP transformation circuitry 208 may be any means embodied in either hardware or a combination of hardware and software that is configured to perform one or more functions disclosed herein related to the SRP transformation engine 110. In one or more examples, the beamforming audio processing apparatus 202 may comprise the beamforming audio processing circuitry 210. The beamforming audio processing circuitry 210 may be any means embodied in either hardware or a combination of hardware and software that is configured to perform one or more functions disclosed herein related to the beamforming steering engine 111, the beamforming selection engine 112, and/or other audio processing of the audio data 106 received from the one or more capture devices 102.

In some examples, the beamforming audio processing apparatus 202 may comprise the input/output circuitry 212 that may, in turn, be in communication with processor 204 to provide output to the user and, in some examples, to receive an indication of a user input. The input/output circuitry 212 may comprise a user interface and may comprise a display. In some examples, the input/output circuitry 212 may also comprise a keyboard, a touch screen, touch areas, soft keys, buttons, knobs, or other input/output mechanisms.

In some examples, the beamforming audio processing apparatus 202 may comprise the communications circuitry 214. The communications circuitry 214 may be any means embodied in either hardware or a combination of hardware and software that is configured to receive and/or transmit data from/to a network and/or any other device or module in communication with the beamforming audio processing apparatus 202. In this regard, the communications circuitry 214 may comprise, for example, an antennae or one or more other communication devices for enabling communications with a wired or wireless communication network. For example, the communications circuitry 214 may comprise antennae, one or more network interface cards, buses, switches, routers, modems, and supporting hardware and/or software, or any other device suitable for enabling communications via a network. Additionally or alternatively, the communications circuitry 214 may comprise the circuitry for interacting with the antenna/antennae to cause transmission of signals via the antenna/antennae or to handle receipt of signals received via the antenna/antennae.

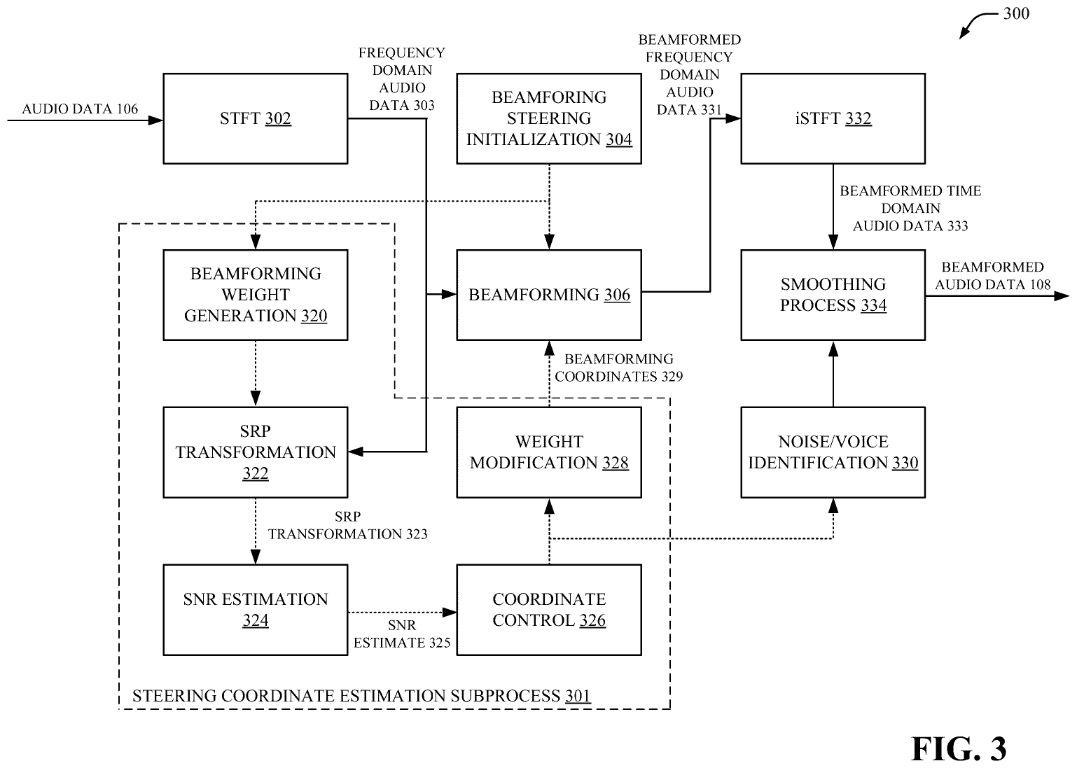

FIG. 3 illustrates a beamforming audio processing flow 300 for beamforming steering enabled by the SRP transformation engine 110 and the beamforming steering engine 111 of FIG. 1 according to one or more embodiments of the present disclosure. The beamforming audio processing flow 300 includes short-term Fourier transform (STFT) 302, beamforming steering initialization 304, beamforming 306, beamforming weight generation 320, SRP transformation 322, SNR estimation 324, coordinate control 326, and/or weight modification 328. The beamforming weight generation 320, the SRP transformation 322, the SNR estimation 324, the coordinate control 326, and/or the weight modification 328 may correspond to a steering coordinate estimation subprocess 301 of the beamforming audio processing flow 300. To further enhance the beamforming 306, the beamforming audio processing flow 300 may additionally or alternatively include noise/voice identification 330, inverse STFT (iSTFT) 332, and/or smoothing process 334.

The STFT 302 may apply a digital transform such as, for example, an STFT or other Fourier-related transform, to the audio data 106 to determine frequency information and/or phase information related to the audio data 106. For example, the audio data 106 may be time domain audio data and the STFT 302 may convert the time domain audio data into frequency domain audio data 303. In some examples, the STFT 302 may convert respective portions of the audio data 106 into respective frequency domain bins such that the frequency domain audio data 303 includes the respective frequency domain bins. The beamforming steering initialization 304 may initiate the beamforming 306 and the steering coordinate estimation subprocess 301 at least approximately in parallel.

The beamforming 306 may perform a first beamforming process to calculate one or more beamforming signals based on the frequency domain audio data 303. For example, the beamforming 306 may employ the respective frequency domain bins associated with the audio data 106 to calculate one or more beamforming signals. Additionally, the beamforming weight generation 320 of the steering coordinate estimation subprocess 301 may determine respective candidate weights for a set of candidate steering coordinates for the beamforming 306. For example, the set of candidate steering coordinates may be a set of default steering coordinates or a set of initial steering coordinates predetermined during initialization of a spatial coordinate grid representing an audio environment associated with the audio data 106.

The frequency domain audio data 303 may also be provided as input to the SRP transformation 322 of the steering coordinate estimation subprocess 301. The SRP transformation 322 may generate an SRP transformation 323 of the frequency domain audio data 303 associated with the audio data 106. In some examples, the SRP transformation 322 may determine an SRP transformation of a subset of the frequency domain audio data 303 that correspond a particular degree of energy such as, for example, where a certain degree of voice energy is concentrated. For instance, beamforming weights provided by the beamforming weight generation 320 may be utilized to calculate the SRP transformation 322. The beamforming weights may be a subset of beamforming coefficients utilized for steered beamforming associated with the beamforming steering initialization 304. Accordingly, SRP may be calculated from beamformed audio over a particular range of frequencies that is less than a full frequency spectrum. The SRP transformation 323 of the SRP transformation 322 may provide a set of SRP weights for the spatial coordinate grid representing the audio environment associated with the audio data 106.

For given coordinate resolution, the SRP transformation 322 may calculate a set of SRP weights for a unity-gain and null-gain. The set of SRP weights related to unity-gain may be defined as:

$$\{ {W}_{mn}^{U} , m = 1 , … M , n = 1 , … N \} \qquad ( 1 )$$

where wₘₙ^{U} may be a vector of weights related to unity-gain for microphone array m at a spatial coordinate grid n, and U may correspond to unity-gain SRP. Additionally, M may represent a total number of microphones used in the beamforming 306 and/or the SRP transformation 322, and N may correspond to a total number of coordinates in the spatial coordinate grid. Similarly, the set of SRP weights related to null-gain may be defined as:

$$\{ {W}_{mn}^{N} , m = 1 , … M , n = 1 , … N \} \qquad ( 2 )$$

where wₘₙ^{N} is a vector of weights related to null-gain for the microphone m and N may correspond to null-gain SRP.

In some examples, the SRP transformation 322 may compare steering coordinates against predefined polar patterns to verify the steering coordinates. For example, when generating null-gain coefficients, a set of check points of direction gain may be verified against unity-gain polar patterns. The set of check points may be related to respective steering locations such as [g₋₉₀, g₋₄₅, g₊₄₅, g₊₉₀] such that the null-gain coefficient is generated at based on a matching gain being provided at [g₋₉₀, g₋₄₅, g₊₄₅, g₊₉₀]. The set of check points may also be relative to an orientation of the microphone array.

In some examples, with the SRP weights and audio inputs, the SRP transformation 322 may calculate beamformer output power denoted as SPRₙ^{U}, and SPRₙ^{N} respectively from unity-gain SRP and null-gain SRP at spatial coordinate grid n. Further the estimated SNRₙ at spatial coordinate grid n may be estimated as:

$${SNR}_{n} = {SPR}_{n}^{U} / {SPR}_{n}^{N} \qquad ( 3 )$$

The SNR estimation 324 may generate an SNR estimate 325 associated with the SRP transformation 323. The SNR estimate 325 may be employed to facilitate beamforming steering. Additionally or alternatively, the SNR estimate 325 may be employed as a confidence metric for the SNR estimation 324. For example, the coordinate control 326 may employ the SNR estimate 325 to control an amount of change to steering coordinates for at least one beamforming lobe associated with the beamforming 306. In some examples, the coordinate control 326 may be utilized to reduce a degree of jitter for coordinate change variance related to SNR based on an amount of change for the coordinate change variance.

In some examples, the SNR estimation 324 may estimate the optimum location index nₒₚₜ^{t} at a current beamforming frame by:

$${n}_{opt}^{t} = \{ \begin{matrix}n , & if ( {max}_{n} ( {SPR}_{n} ) ) and ( {SNR}_{n} > TH ) \\ {n}_{opt}^{t - 1} , & otherwise\end{matrix} \qquad ( 4 )$$

where TH is a sound measure threshold (e.g., 3.0 dB) to avoid tracking to ambient noise, and nₒₚₜ^{t-1} is a previous frame location index.

In some examples, to avoid coordinate fluctuations, the SNR estimation 324 may apply a maximum 5-degree limit to nₒₚₜ^{t} per frame, if (nₒₚₜ^{t}-nₒₚₜ^{t-1}) is more than 5 degrees.

The weight modification 328 may generate beamforming coordinates 329 for the beamforming 306. In some examples, the beamforming coordinates 329 may be configured based on the SRP weights associated with the SRP transformation 323. For instance, the weight modification 328 may determine whether or not to update weighting for the beamforming based on the SNR estimate 325 associated with the SRP transformation 343. In some examples, the SRP weights associated with the SRP transformation 323 may be applied to a previous version of beamforming coordinates for the beamforming 306 and/or a related spatial coordinate grid to provide the beamforming coordinates 329. Based on the frequency domain audio data 303 and the beamforming coordinates 329, the beamforming 306 may generate beamformed frequency domain audio data 331. The iSTFT 332 may convert the beamformed frequency domain audio data 331 into beamformed time domain audio data 333. In some examples, the smoothing process 334 may apply smoothing to one or more portions of the beamformed time domain audio data 333 to generate the beamformed audio data 108. In some examples, the smoothing process 334 may be executed based on the noise/voice identification 330. For example, a degree of smoothing by the smoothing process 334 may be based on identified noise, voice or other undesirable audio associated with the audio data 106.

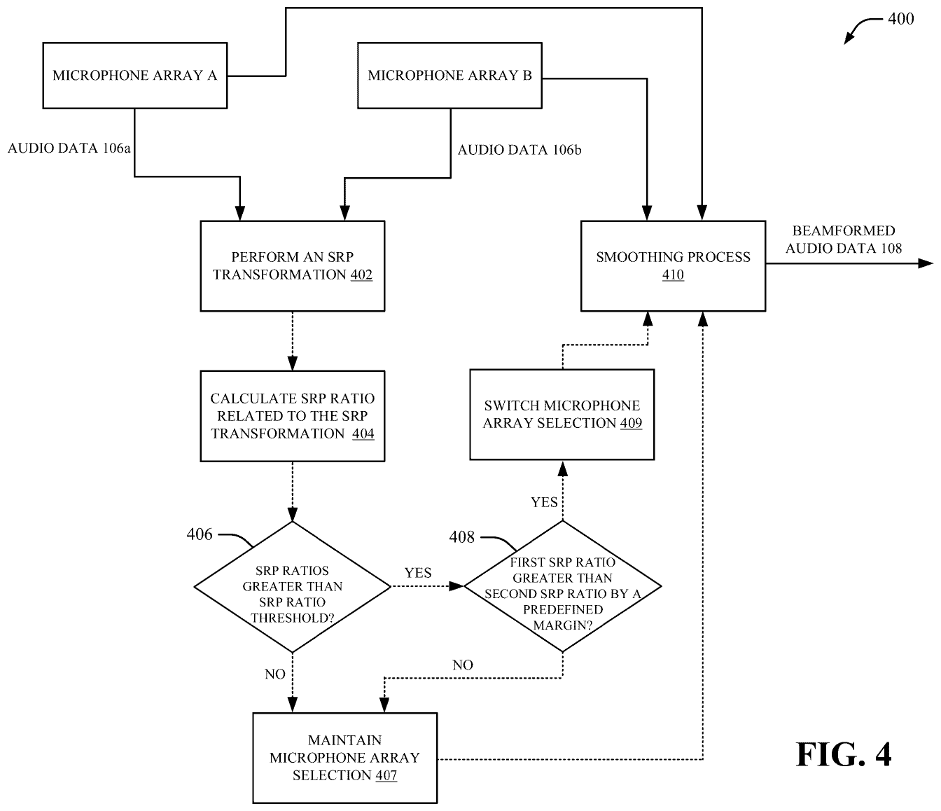

FIG. 4 illustrates a beamforming audio processing flow 400 for beamforming selection enabled by the SRP transformation engine 110 and the beamforming selection engine 112 of FIG. 1 according to one or more embodiments of the present disclosure. The beamforming audio processing flow 400 may correspond to an example where the one or more capture devices 102 correspond to at least a microphone array A that produces audio data 106a and a microphone array B that produces audio data 106b. In some examples, the microphone array A may be a horizontal microphone array in an audio environment and the microphone array B may be a vertical microphone array in the audio environment.

The beamforming audio processing flow 400 includes a step 402 that performs an SRP transformation for the audio data 106a provided by the microphone array A and the audio data 106b provided by the microphone array B. In some examples, the SRP transformation of step 402 includes a respective unity-gain and/or null-gain SRP transformation for the audio data 106a and the audio data 106b.

The beamforming audio processing flow 400 may also include a step 404 that calculates an SRP ratio related to the SRP transformation. The SRP ratio may include a first SRP ratio related to the audio data 106a and a second SRP ratio related to the audio data 106b. For example, the first SRP ratio may correspond to a ratio of the unity-gain SRP transformation and the null-gain SRP transformation for the audio data 106a. Additionally, the second SRP ratio may correspond to a ratio of the unity-gain SRP transformation and the null-gain SRP transformation for the audio data 106b. In some examples, the SRP ratio may correspond to a SNR estimate. For instance, the first SRP ratio may correspond to a first SNR estimate and the second SRP ratio may correspond to a second SNR estimate.

In some examples, the SRP transformation may define unity-gain steered coefficient as:

$$\{ {W}_{m}^{U} , m = 1 , … M \} , \qquad ( 5 )$$

where wₘ^{U} is a vector of weights for microphone m, U is a unity-gain over steered coordinate, and M is the total number of microphones used in the beamforming.

Similarly, the SRP transformation may define null-gain steered coefficient as:

$$\{ {W}_{m}^{N} , m = 1 , … M \} . \qquad ( 6 )$$

When generating null-gain coefficients, several check points of direction gain may be verified against unity-gain polar patterns. For example, four steering locations may be checked. Assuming the magnitude of unity-gain detected at steered azimuths with offset of [±45, ±90] are [g₋₉₀, g₋₄₅, g₊₄₅, g₊₉₀] respectively, the null-gain coefficient may be generated at the condition that same gain as [g₋₉₀, g₋₄₅, g₊₄₅, g₊₉₀] at these check points will be matched. The check-point angle in azimuth may be relative to the orientation of the microphone array. As an example, the check-point azimuth may be the same azimuth for a horizontal array and may be the same as elevation angles for a vertical array referenced to the origin.

Assuming the time domain microphone m signal is defined xₘ(n), where n refer to sample index. The Fourier transform of microphone m signal at frequency index k Xₘ(k) may be defined as:

$${x}_{m} ( k ) {=}^{△} {\sum }_{n = 0}^{N - 1} {x}_{m} ( n ) {e}^{- j 2 π \frac{nk}{N}} , \qquad ( 7 )$$

where k is the bin index from 0 to 255.

In various examples, the beamformer output y(k) may be defined as:

$$y ( k ) {=}^{△} {W}^{H} X ( k ) = {\sum }_{0}^{M - 1} {w}_{m}^{*} {x}_{m} ( k ) , \qquad ( 8 )$$

where X(k) is the vector of the Fourier transform of microphone m and W^{H} is a weight vector.

The partial coefficient beamformer outputs may be defined as y^{U}_{A}, y^{N}_{A}, y^{U}_{B}, y^{N}_{B} respectively from unity-gain of microphone array A, null-gain of microphone array A, unity-gain of microphone array B, and null-gain of microphone array B. Additionally, y may be a vector with dimension of number of bins used for partial coefficient beamforming. In some examples, the steering power response (SRP) may be defined as:

$${SPR}_{A}^{U} = norm ( {y}_{A}^{U} ) , \qquad ( 9 )$$

$${SPR}_{A}^{N} = norm ( {y}_{A}^{N} ) , \qquad ( 10 )$$

$${SPR}_{B}^{U} = norm ( {y}_{B}^{U} ) , \qquad ( 11 )$$

$${SPR}_{B}^{N} = norm ( {y}_{B}^{N} ) , \qquad ( 12 )$$

where U refers to unity-gain and N refers to null-gain SRP.

With SRPs, the SRP transformation may calculate the power difference as:

$${{diff}_{SPR}}_{A}^{U} = 20 log ( {SPR}_{A}^{U} ) - 20 log ( {SPR}_{A}^{N} ) \qquad ( 13 )$$

$${{diff}_{SPR}}_{B}^{U} = 20 log ( {SPR}_{B}^{U} ) - 20 log ( {SPR}_{B}^{N} ) \qquad ( 14 )$$

If diff_SPR_{A}^{U} is above the ThresA (e.g., 8.0 dB) and diff_SPR_{B}^{U} is above the ThresB (e.g., 5.0 dB), the SRP transformation may further verify which microphone array obtains the max unity-gain power as:

$$Using A or B = \{ \begin{matrix}A , if ( 20 log ( {SPR}_{A}^{U} ) > 20 log ( {SPR}_{B}^{U} ) + Margin ) \\ B , if ( 20 log ( {SPR}_{B}^{U} ) > 20 log ( {SPR}_{A}^{U} ) + Margin ) \\ No switch\end{matrix} , \qquad ( 15 )$$

where Margin is a safety check to minimize unnecessary swapping of the outputs. A margin value for the Margin may be, for example, 2.0 dB or another dB value.

The beamforming audio processing flow 400 may also include a step 406 that determines whether the SRP ratios are greater than an SRP ratio threshold. For example, step 406 may determine whether the first SRP ratio and the second SRP ratio are greater than an SRP ratio threshold. If no, a microphone array selection may be maintained at step 407. For example, selection of either the microphone array A or the microphone array B to output beamformed audio data may be maintained as previously selected for a previous beamforming process. However, if yes, the beamforming audio processing flow 400 may proceed to step 408.

The step 408 of the beamforming audio processing flow 400 may determine whether the first SRP ratio is greater than the second SRP ratio by a predefined margin. For example, the step 408 may determine whether a difference between the first SRP ratio associated with the audio data 106a and the second SRP ratio associated with the audio data 106b is greater than a predefined distance. If no, a microphone array selection may be maintained at step 407. However, if yes, the beamforming audio processing flow 400 may proceed to step 409. The step 409 of the beamforming audio processing flow 400 may with a microphone array selection. For example, selection of either the microphone array A or the microphone array B (e.g., to output beamformed audio data) as previously selected for a previous beamforming process may be switched.

The beamforming audio processing flow 400 may also include a step 410 that performs a smoothing process. The smoothing process may apply smoothing to one or more portions of beamformed audio data 108 for the microphone array selected via the step 409 of the beamforming audio processing flow 400. In some examples, the smoothing process associated with the step 410 may overlap audio outputs from microphone array A and microphone array B using, for example, a Hanning window technique for respective beamforming frames to ramp down a previous source of audio and/or to ramp up a new source of audio to further improve smoothing of audio for the beamformed audio data 108.

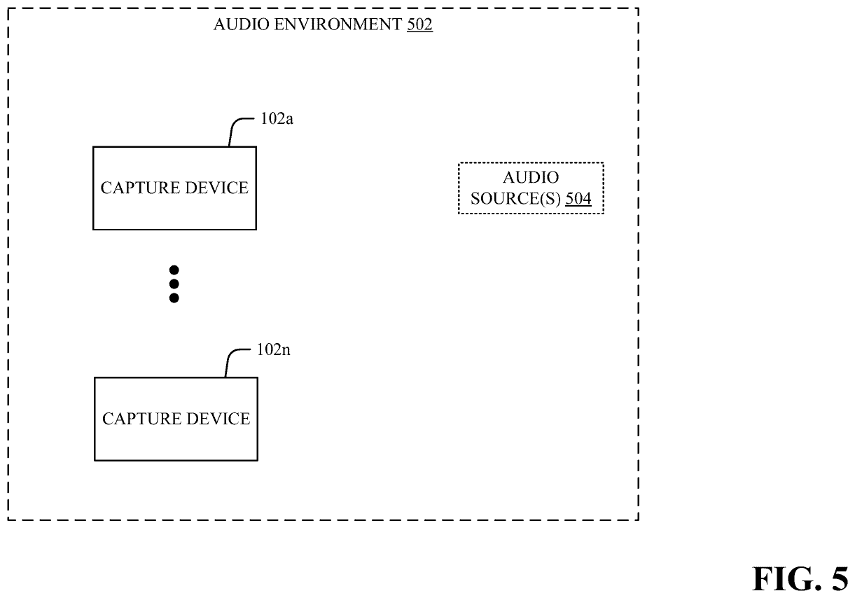

FIG. 5 illustrates an example audio environment 502 according to one or more embodiments of the present disclosure. The audio environment 502 may be an indoor environment, an outdoor environment, a room, an auditorium, a performance hall, a broadcasting environment, an arena (e.g., a sports arena), a virtual environment, or another type of audio environment. The audio environment 502 includes the one or more capture devices 102a-n that are respectively capable of capturing audio from one or more audio sources 504. In some examples, the one or more capture devices 102a-n are respectively configured as microphone arrays. In some examples, the one or more capture devices 102a-n comprise at least a first microphone array arranged in a vertical orientation in the audio environment 502 and a second microphone array arranged in a horizontal orientation in the audio environment 502. In some examples, the capture devices 102a-n may be configured in a fixed geometry microphone arrangement (e.g., a constellation microphone arrangement) to extract audio content across the audio capture areas 704a-n.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

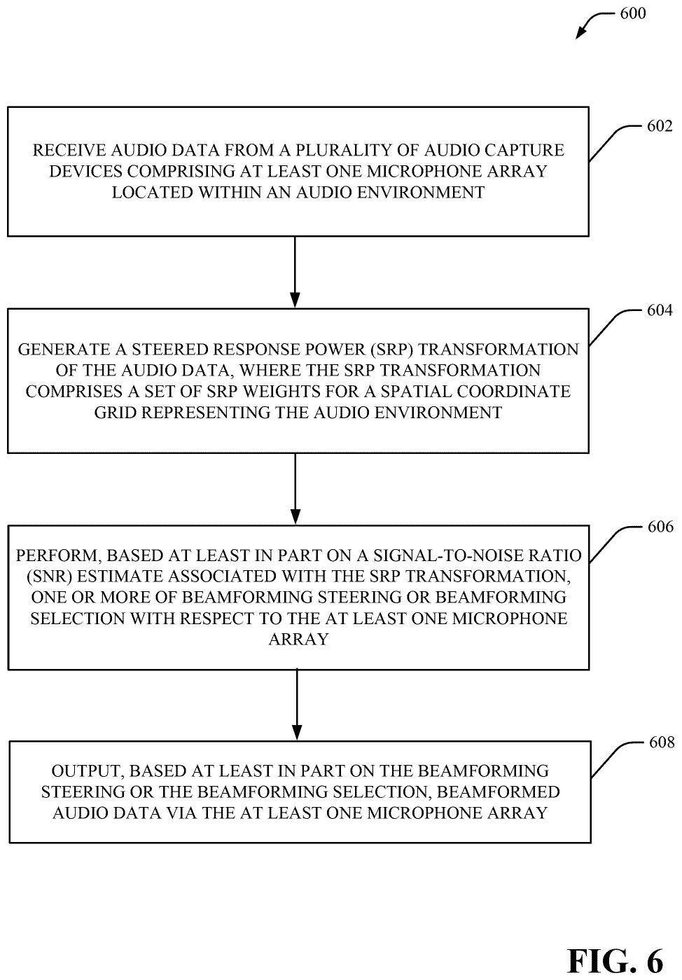

FIG. 6 is a flowchart diagram of an example process 600, for providing beamforming for at least one microphone array based on an SRP transformation of audio data, in accordance with, for example, the beamforming audio processing apparatus 202 illustrated in FIG. 2. Via the various operations of the process 600, the beamforming audio processing apparatus 202 may enhance quality and/or reliability of beamformed audio data.

The process 600 begins at operation 602 that receives (e.g., by the SRP transformation circuitry 208 and/or the beamforming audio processing circuitry 210) audio data from a plurality of audio capture devices comprising at least one microphone array located within an audio environment. In some examples, the process 600 additionally or alternatively includes receiving the audio data from multiple audio capture devices configured as at least one microphone array located within the audio environment. The audio environment may be an indoor environment, an outdoor environment, a room, an auditorium, a performance hall, a broadcasting environment, an arena (e.g., a sports arena), a virtual environment, or another type of audio environment.

The process 600 also includes an operation 604 that generates (e.g., by the SRP transformation circuitry 208) a steered response power (SRP) transformation of the audio data, where the SRP transformation comprises a set of SRP weights for a spatial coordinate grid representing the audio environment. In some examples, predefined beamforming coefficients may be applied to respective values of the spatial coordinate grid to generate the SRP transformation. In some examples, the process 600 additionally or alternatively includes generating, based at least in part on the audio data, a set of SRP weights for the spatial coordinate grid representing the audio environment. In some examples, the SRP transformation may be generated for a portion of the audio data associated with a particular degree of energy.

The process 600 also includes an operation 606 that performs (e.g., by the beamforming audio processing circuitry 210) one or more of beamforming steering or beamforming selection with respect to the at least one microphone array based at least in part on a signal-to-noise ratio (SNR) estimate associated with the SRP transformation. In some examples, the process 600 additionally or alternatively includes performing, based at least in part on the set of SRP weights, one or more of beamforming steering or beamforming selection with respect to the at least one microphone array. In some examples, steering coordinates for at least one beamforming lobe associated with the at least one microphone array is determined based at least in part on the SRP transformation of the audio data. In some examples, a first microphone array or a second microphone array is selected to output the beamformed audio data. In some examples, a first microphone array or a second microphone array is selected to output the beamformed audio data based at least in part on a comparison between the SRP transformation of the audio data and an alternate SRP transformation of the audio data.

In some examples, the process 600 additionally or alternatively includes determining steering coordinates for at least one beamforming lobe associated with the at least one microphone array based at least in part on the SRP transformation of the audio data. In some examples, the process 600 additionally or alternatively includes performing one or more of the beamforming steering or the beamforming selection with respect to the at least one microphone array based at least in part on the steering coordinates.

In some examples, the process 600 additionally or alternatively includes determining steering coordinates for at least one beamforming lobe associated with the at least one microphone array based at least in part on the SRP transformation of the audio data. In some examples, the process 600 additionally or alternatively includes comparing the steering coordinates against predefined polar patterns to verify the steering coordinates. In some examples, the process 600 additionally or alternatively includes performing one or more of the beamforming steering or the beamforming selection with respect to the at least one microphone array based at least in part on the steering coordinates.

In some examples, the process 600 additionally or alternatively includes determining steering coordinates for at least one beamforming lobe associated with the at least one microphone array based at least in part on the SRP transformation of the audio data. In some examples, the process 600 additionally or alternatively includes comparing the steering coordinates to a previous beamformed frame to verify the steering coordinates. In some examples, the process 600 additionally or alternatively includes performing one or more of the beamforming steering or the beamforming selection with respect to the at least one microphone array based at least in part on the steering coordinates.

In some examples, the process 600 additionally or alternatively includes determining steering coordinates for at least one beamforming lobe associated with the at least one microphone array based at least in part on the SRP transformation of the audio data and predefined beamforming weights associated with the spatial coordinate grid.

In some examples, the process 600 additionally or alternatively includes determining steering coordinates for multiple beamforming lobe associated with the at least one microphone array based at least in part on the SRP transformation of the audio data. In some examples, the process 600 additionally or alternatively includes steering the multiple beamforming lobes of the microphone array based at least in part on the steering coordinates.

In some examples, the process 600 additionally or alternatively includes determining steering coordinates for at least one beamforming lobe associated with the at least one microphone array in parallel to a different beamforming process for the audio data.

In some examples, the process 600 additionally or alternatively includes determining the SNR estimate using at least one of unity-gain steering or null-gain steering properties of the audio data.

The process 600 also includes an operation 608 that outputs (e.g., by the beamforming audio processing circuitry 210) beamformed audio data via the at least one microphone array based at least in part on the beamforming steering or the beamforming selection. In some examples, the beamformed audio data is output toward a sound source associated with the steering coordinates.

In some examples, the process 600 additionally or alternatively includes applying spatial filtering of the audio data based at least in part on the steering coordinates to generate the beamformed audio data for the at least one microphone array. In some examples, the process 600 additionally or alternatively includes outputting the beamformed audio data toward a sound source associated with the steering coordinates.

In some examples, the process 600 additionally or alternatively includes selecting a first microphone array or a second microphone array to output the beamformed audio data based at least in part on a comparison between the SRP transformation of the audio data and an alternate SRP transformation of the audio data. In some examples, the process 600 additionally or alternatively includes selecting a beamforming lobe for the at least one microphone array to output the beamformed audio data based at least in part on the SNR estimate associated with the SRP transformation.

In some examples, the process 600 additionally or alternatively includes determining a confidence value for the steering coordinates based at least in part on the SNR estimate. In some examples, the process 600 additionally or alternatively includes applying spatial filtering of the audio data based at least in part on the confidence value satisfying a confidence threshold.

In some examples, the process 600 additionally or alternatively includes determining a confidence value for the steering coordinates based at least in part on the SNR estimate. In some examples, the process 600 additionally or alternatively includes updating beamforming weights for the audio data based at least in part on the confidence value satisfying a confidence threshold.

In some examples, the process 600 additionally or alternatively includes comparing the SNR estimate to a different SNR estimate for a different microphone array. In some examples, the process 600 additionally or alternatively includes generating the beamformed audio data responsive to a determination that the SNR estimate is greater than the different SNR estimate.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, i.e., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. A beamforming audio processing apparatus comprising at least one processor and a memory storing instructions that are operable, when executed by the processor, to cause the beamforming audio processing apparatus to: receive audio data from a plurality audio capture devices comprising at least one microphone array located within an audio environment.

Clause 2. The beamforming audio processing apparatus of clause 1, wherein the instructions are further operable to cause the beamforming audio processing apparatus to: generate a steered response power (SRP) transformation of the audio data.

Clause 3. The beamforming audio processing apparatus of any one of the foregoing clauses, wherein the SRP transformation comprises a set of SRP weights for a spatial coordinate grid representing the audio environment.

Clause 4. The beamforming audio processing apparatus of any one of the foregoing clauses, wherein the instructions are further operable to cause the beamforming audio processing apparatus to: perform, based at least in part on a signal-to-noise ratio (SNR) estimate associated with the SRP transformation, one or more of beamforming steering or beamforming selection with respect to the at least one microphone array.

Clause 5. The beamforming audio processing apparatus of any one of the foregoing clauses, wherein the instructions are further operable to cause the beamforming audio processing apparatus to: output, based at least in part on the beamforming steering or the beamforming selection, beamformed audio data via the at least one microphone array.

Clause 6. The beamforming audio processing apparatus of any one of the foregoing clauses, wherein the instructions are further operable to cause the beamforming audio processing apparatus to: determine steering coordinates for at least one beamforming lobe associated with the at least one microphone array based at least in part on the SRP transformation of the audio data.

Clause 7. The beamforming audio processing apparatus of any one of the foregoing clauses, wherein the instructions are further operable to cause the beamforming audio processing apparatus to: perform one or more of the beamforming steering or the beamforming selection with respect to the at least one microphone array based at least in part on the steering coordinates.

Clause 8. The beamforming audio processing apparatus of any one of the foregoing clauses, wherein the instructions are further operable to cause the beamforming audio processing apparatus to: apply spatial filtering of the audio data based at least in part on the steering coordinates to generate the beamformed audio data for the at least one microphone array.

Clause 9. The beamforming audio processing apparatus of any one of the foregoing clauses, wherein the instructions are further operable to cause the beamforming audio processing apparatus to: output the beamformed audio data toward a sound source associated with the steering coordinates.

Clause 10. The beamforming audio processing apparatus of any one of the foregoing clauses, wherein the instructions are further operable to cause the beamforming audio processing apparatus to: select a first microphone array or a second microphone array to output the beamformed audio data based at least in part on a comparison between the SRP transformation of the audio data and an alternate SRP transformation of the audio data.

Clause 11. The beamforming audio processing apparatus of any one of the foregoing clauses, wherein the instructions are further operable to cause the beamforming audio processing apparatus to: select a beamforming lobe for the at least one microphone array to output the beamformed audio data based at least in part on the SNR estimate associated with the SRP transformation.

Clause 12. The beamforming audio processing apparatus any one of the foregoing clauses, wherein the instructions are further operable to cause the beamforming audio processing apparatus to: apply predefined beamforming coefficients to respective values of the spatial coordinate grid to generate the SRP transformation.

Clause 13. The beamforming audio processing apparatus of any one of the foregoing clauses, wherein the instructions are further operable to cause the beamforming audio processing apparatus to: determine steering coordinates for at least one beamforming lobe associated with the at least one microphone array based at least in part on the SRP transformation of the audio data.

Clause 14. The beamforming audio processing apparatus of any one of the foregoing clauses, wherein the instructions are further operable to cause the beamforming audio processing apparatus to: compare the steering coordinates against predefined polar patterns to verify the steering coordinates.

Clause 15. The beamforming audio processing apparatus of any one of the foregoing clauses, wherein the instructions are further operable to cause the beamforming audio processing apparatus to: perform one or more of the beamforming steering or the beamforming selection with respect to the at least one microphone array based at least in part on the steering coordinates.

Clause 16. The beamforming audio processing apparatus of any one of the foregoing clauses, wherein the instructions are further operable to cause the beamforming audio processing apparatus to: determine steering coordinates for at least one beamforming lobe associated with the at least one microphone array based at least in part on the SRP transformation of the audio data.

Clause 17. The beamforming audio processing apparatus of any one of the foregoing clauses, wherein the instructions are further operable to cause the beamforming audio processing apparatus to: compare the steering coordinates to a previous beamformed frame to verify the steering coordinates.

Clause 18. The beamforming audio processing apparatus of any one of the foregoing clauses, wherein the instructions are further operable to cause the beamforming audio processing apparatus to: perform one or more of the beamforming steering or the beamforming selection with respect to the at least one microphone array based at least in part on the steering coordinates.

Clause 19. The beamforming audio processing apparatus of any one of the foregoing clauses, wherein the instructions are further operable to cause the beamforming audio processing apparatus to: determine steering coordinates for at least one beamforming lobe associated with the at least one microphone array based at least in part on the SRP transformation of the audio data and predefined beamforming weights associated with the spatial coordinate grid.

Clause 20. The beamforming audio processing apparatus of any one of the foregoing clauses, wherein the instructions are further operable to cause the beamforming audio processing apparatus to: determine a confidence value for the steering coordinates based at least in part on the SNR estimate.

Clause 21. The beamforming audio processing apparatus of any one of the foregoing clauses, wherein the instructions are further operable to cause the beamforming audio processing apparatus to: apply spatial filtering of the audio data based at least in part on the confidence value satisfying a confidence threshold.

Clause 22. The beamforming audio processing apparatus of any one of the foregoing clauses, wherein the instructions are further operable to cause the beamforming audio processing apparatus to: update beamforming weights for the audio data based at least in part on the confidence value satisfying a confidence threshold.

Clause 23. The beamforming audio processing apparatus of any one of the foregoing clauses, wherein the instructions are further operable to cause the beamforming audio processing apparatus to: determine steering coordinates for multiple beamforming lobe associated with the at least one microphone array based at least in part on the SRP transformation of the audio data.

Clause 24. The beamforming audio processing apparatus of any one of the foregoing clauses, wherein the instructions are further operable to cause the beamforming audio processing apparatus to: steer the multiple beamforming lobes of the microphone array based at least in part on the steering coordinates.

Clause 25. The beamforming audio processing apparatus of any one of the foregoing clauses, wherein the instructions are further operable to cause the beamforming audio processing apparatus to: determine steering coordinates for at least one beamforming lobe associated with the at least one microphone array in parallel to a different beamforming process for the audio data.

Clause 26. The beamforming audio processing apparatus of any one of the foregoing clauses, wherein the instructions are further operable to cause the beamforming audio processing apparatus to: determine the SNR estimate using at least one of unity-gain steering or null-gain steering properties of the audio data.

Clause 27. The beamforming audio processing apparatus of any one of the foregoing clauses, wherein the instructions are further operable to cause the beamforming audio processing apparatus to: compare the SNR estimate to a different SNR estimate for a different microphone array.

Clause 28. The beamforming audio processing apparatus of any one of the foregoing clauses, wherein the instructions are further operable to cause the beamforming audio processing apparatus to: responsive to a determination that the SNR estimate is greater than the different SNR estimate, generate the beamformed audio data.

Clause 29. The beamforming audio processing apparatus of any one of the foregoing clauses, wherein the instructions are further operable to cause the beamforming audio processing apparatus to: generate the SRP transformation for a portion of the audio data associated with a particular degree of energy.

Clause 30. A computer-implemented method comprising steps in accordance with any one of the foregoing clauses 1-29.

Clause 31. A computer program product, stored on a computer readable medium, comprising instructions that, when executed by one or more processors of beamforming audio processing apparatus, cause the one or more processors to perform one or more operations related to any one of the foregoing clauses 1-29.

Clause 32. A beamforming audio processing apparatus comprising at least one processor and a memory storing instructions that are operable, when executed by the processor, to cause the beamforming audio processing apparatus to: receive audio data from multiple audio capture devices configured as at least one microphone array located within an audio environment.

Clause 33. The beamforming audio processing apparatus of clause 32, wherein the instructions are further operable to cause the beamforming audio processing apparatus to: generate, based at least in part on the audio data, a set of SRP weights for a spatial coordinate grid representing the audio environment.

Clause 34. The beamforming audio processing apparatus of any one of the foregoing clauses, wherein the instructions are further operable to cause the beamforming audio processing apparatus to: perform, based at least in part on the set of SRP weights, one or more of beamforming steering or beamforming selection with respect to the at least one microphone array.

Clause 35. The beamforming audio processing apparatus of any one of the foregoing clauses, wherein the instructions are further operable to cause the beamforming audio processing apparatus to: output, based at least in part on the beamforming steering or the beamforming selection, beamformed audio data via the at least one microphone array.

Clause 36. A computer-implemented method comprising steps in accordance with any one of the foregoing clauses 32-35.

Clause 37. A computer program product, stored on a computer readable medium, comprising instructions that, when executed by one or more processors of beamforming audio processing apparatus, cause the one or more processors to perform one or more operations related to any one of the foregoing clauses 32-35.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. A beamforming audio processing apparatus comprising at least one processor and a memory storing instructions that are operable, when executed by the processor, to cause the beamforming audio processing apparatus to:
receive audio data from a plurality audio capture devices comprising at least one microphone array located within an audio environment;
generate a steered response power (SRP) transformation of the audio data, wherein the SRP transformation comprises a set of SRP weights for a spatial coordinate grid representing the audio environment;
perform, based at least in part on a signal-to-noise ratio (SNR) estimate associated with the SRP transformation, one or more of beamforming steering or beamforming selection with respect to the at least one microphone array; and
output, based at least in part on the beamforming steering or the beamforming selection, beamformed audio data via the at least one microphone array.

2. The beamforming audio processing apparatus of claim 1, wherein the instructions are further operable to cause the beamforming audio processing apparatus to:
determine steering coordinates for at least one beamforming lobe associated with the at least one microphone array based at least in part on the SRP transformation of the audio data; and
perform one or more of the beamforming steering or the beamforming selection with respect to the at least one microphone array based at least in part on the steering coordinates.

3. The beamforming audio processing apparatus of claim 2, wherein the instructions are further operable to cause the beamforming audio processing apparatus to:
apply spatial filtering of the audio data based at least in part on the steering coordinates to generate the beamformed audio data for the at least one microphone array; and
output the beamformed audio data toward a sound source associated with the steering coordinates.

4. The beamforming audio processing apparatus of claim 1, wherein the instructions are further operable to cause the beamforming audio processing apparatus to:
select a first microphone array or a second microphone array to output the beamformed audio data based at least in part on a comparison between the SRP transformation of the audio data and an alternate SRP transformation of the audio data.

5. The beamforming audio processing apparatus of claim 1, wherein the instructions are further operable to cause the beamforming audio processing apparatus to:
select a beamforming lobe for the at least one microphone array to output the beamformed audio data based at least in part on the SNR estimate associated with the SRP transformation.

6. The beamforming audio processing apparatus of claim 1, wherein the instructions are further operable to cause the beamforming audio processing apparatus to:
apply predefined beamforming coefficients to respective values of the spatial coordinate grid to generate the SRP transformation.

7. The beamforming audio processing apparatus of claim 1, wherein the instructions are further operable to cause the beamforming audio processing apparatus to:
determine steering coordinates for at least one beamforming lobe associated with the at least one microphone array based at least in part on the SRP transformation of the audio data;
compare the steering coordinates against predefined polar patterns to verify the steering coordinates; and
perform one or more of the beamforming steering or the beamforming selection with respect to the at least one microphone array based at least in part on the steering coordinates.

8. The beamforming audio processing apparatus of claim 1, wherein the instructions are further operable to cause the beamforming audio processing apparatus to:
determine steering coordinates for at least one beamforming lobe associated with the at least one microphone array based at least in part on the SRP transformation of the audio data;
compare the steering coordinates to a previous beamformed frame to verify the steering coordinates; and
perform one or more of the beamforming steering or the beamforming selection with respect to the at least one microphone array based at least in part on the steering coordinates.

9. The beamforming audio processing apparatus of claim 1, wherein the instructions are further operable to cause the beamforming audio processing apparatus to:
determine steering coordinates for at least one beamforming lobe associated with the at least one microphone array based at least in part on the SRP transformation of the audio data
determine a confidence value for the steering coordinates based at least in part on the SNR estimate; and
apply spatial filtering of the audio data based at least in part on the confidence value satisfying a confidence threshold.

10. The beamforming audio processing apparatus of claim 1, wherein the instructions are further operable to cause the beamforming audio processing apparatus to:
determine steering coordinates for at least one beamforming lobe associated with the at least one microphone array based at least in part on the SRP transformation of the audio data
determine a confidence value for the steering coordinates based at least in part on the SNR estimate; and
update beamforming weights for the audio data based at least in part on the confidence value satisfying a confidence threshold.

11. The beamforming audio processing apparatus of claim 1, wherein the instructions are further operable to cause the beamforming audio processing apparatus to:
compare the SNR estimate to a different SNR estimate for a different microphone array; and
responsive to a determination that the SNR estimate is greater than the different SNR estimate, generate the beamformed audio data.

12. A computer-implemented method performed by an audio signal processing apparatus, comprising:
receiving audio data from a plurality audio capture devices comprising at least one microphone array located within an audio environment;
generating a steered response power (SRP) transformation of the audio data, wherein the SRP transformation comprises a set of SRP weights for a spatial coordinate grid representing the audio environment;
performing, based at least in part on a signal-to-noise ratio (SNR) estimate associated with the SRP transformation, one or more of beamforming steering or beamforming selection with respect to the at least one microphone array; and
outputting, based at least in part on the beamforming steering or the beamforming selection, beamformed audio data via the at least one microphone array.

13. The computer-implemented method of claim 12, further comprising:
determining steering coordinates for at least one beamforming lobe associated with the at least one microphone array based at least in part on the SRP transformation of the audio data; and
performing one or more of the beamforming steering or the beamforming selection with respect to the at least one microphone array based at least in part on the steering coordinates.

14. The computer-implemented method of claim 12, further comprising:
applying spatial filtering of the audio data based at least in part on the steering coordinates to generate the beamformed audio data for the at least one microphone array; and
outputting the beamformed audio data toward a sound source associated with the steering coordinates.

15. The computer-implemented method of claim 12, further comprising:
selecting a first microphone array or a second microphone array to output the beamformed audio data based at least in part on a comparison between the SRP transformation of the audio data and an alternate SRP transformation of the audio data.

16. The computer-implemented method of claim 12, further comprising:
selecting a beamforming lobe for the at least one microphone array to output the beamformed audio data based at least in part on the SNR estimate associated with the SRP transformation.

17. The computer-implemented method of claim 12, further comprising:
applying predefined beamforming coefficients to respective values of the spatial coordinate grid to generate the SRP transformation.

18. The computer-implemented method of claim 12, further comprising:
determining steering coordinates for at least one beamforming lobe associated with the at least one microphone array based at least in part on the SRP transformation of the audio data;
comparing the steering coordinates against predefined polar patterns to verify the steering coordinates; and
performing one or more of the beamforming steering or the beamforming selection with respect to the at least one microphone array based at least in part on the steering coordinates.

19. The computer-implemented method of claim 12, further comprising:
determining steering coordinates for at least one beamforming lobe associated with the at least one microphone array based at least in part on the SRP transformation of the audio data;
comparing the steering coordinates to a previous beamformed frame to verify the steering coordinates; and
performing one or more of the beamforming steering or the beamforming selection with respect to the at least one microphone array based at least in part on the steering coordinates.

20. A computer program product, stored on a computer readable medium, comprising instructions that, when executed by one or more processors of an audio signal processing apparatus, cause the one or more processors to:
receive audio data from a plurality audio capture devices comprising at least one microphone array located within an audio environment;
generate a steered response power (SRP) transformation of the audio data, wherein the SRP transformation comprises a set of SRP weights for a spatial coordinate grid representing the audio environment;
perform, based at least in part on a signal-to-noise ratio (SNR) estimate associated with the SRP transformation, one or more of beamforming steering or beamforming selection with respect to the at least one microphone array; and
output, based at least in part on the beamforming steering or the beamforming selection, beamformed audio data via the at least one microphone array.
